(19) United States
(12) Patent Application Publication
(10) Pub. No.: US 2011/0238628 A1
(43) Pub. Date: Sep. 29, 2011

(54) METHODS, SYSTEMS AND PRODUCTS FOR DATA PRESERVATION

(76) Inventors: James W. Osborne, Sammamish, WA (US); Hong Q. Bui, Laguna Niguel, CA (US); L. Nicholas Brosnahan, Sunnyvale, CA (US); Michael D. McDaniel, Bellevue, WA (US); Philip B. Winant, San Diego, CA (US)

(21) Appl. No.: 13/158,308

(22) Filed: Jun. 10, 2011

Related U.S. Application Data
(63) Continuation of application No. 10/895,612, filed on Jul. 20, 2004, now abandoned.
(60) Provisional application No. 60/541,188, filed on Feb. 2, 2004.

(51) Int. Cl. G06F 17/30

(52) U.S. Cl. 707/654; 707/E17.005

(57) ABSTRACT

A method implementable by an electronic system comprises identifying an event corresponding to a data set, the data set being of a type of a plurality of data-set types; identifying the type of the data set; identifying an association between the type of the data set and an entity of a plurality of entities; and instructing the entity to perform an action with respect to the data set.

### CROSS REFERENCE TO RELATED APPLICATION

This application is a continuation of U.S. patent application Ser. No. 10/895,612, filed Jul. 20, 2004, which claims priority from U.S. Provisional Patent Application No. 60/541,188, filed Feb. 2, 2004, each application of which is hereby incorporated by reference herein.

### BACKGROUND

Traditional computer backup programs for use in the home typically create a replica of all or a large subset of all of the files and folders on a computer hard disk. These replicas are generally stored on some removable medium, such as tape, CD-R, or Zip disk. When a user wants to retrieve a version of a file or files from the backup medium, he or she must locate the disk or tape that contains the desired file and load it into the computer where a restore program can restore the file to the user's hard disk.

With the rapid growth of human-created computer data (email, digital photos, music, etc.), traditional methods of preserving or “backing up” personal computers are becoming less useful and more difficult and time consuming.

The average hard disk size that ships with a new personal computer is growing faster than Moore's Law. However, the capacity of removable media technologies such as CD-R is not keeping pace. The result is that it takes more and more removable media to back up the contents of a computer's hard disk. Moreover, as the number of discs and tapes increase, the likelihood of losing, misplacing, or mislabeling these media and, thus, their contents also increases.

As users continue to create and store more and more “content” files (e.g., digital photos) on their PCs, the difficulty of correctly finding and backing up those files also increases. Some files may be stored in one folder hierarchy, others in a “Desktop” folder. Traditional backup products that use a “tree view” approach to selecting items for backup become more tedious to use. Duplicate files also become more of an issue, as users may copy files from one folder or volume to another as they sort, categorize, or otherwise manipulate their files. Traditional backup products will replicate and store each copy, thereby wasting time and space.

Where users once mainly created relatively small text files in their daily activities, they now produce many more binary files (such as digital photos, music, and movies). These files tend to be orders of magnitude larger than text files and therefore require more time to replicate and take up much more room on the backing store. For example, where it was once reasonable to assume one could back up all their important files to a 100 MB zip disk, or even a 1 MB floppy, that assumption no longer holds true.

As computers become an increasingly ubiquitous tool, people are creating and storing more and more different kinds of data on their hard disks. Tax returns, financial records, letters, address books, photos, and digital music all have varying levels of sentimental, financial, and utilitarian value. However, traditional backup programs treat all of these files in the same manner, regardless of sensitivity and/or value to the user.

Existing backup software typically requires the user's periodic interaction, usually to insert a new disc or tape or to initiate a network connection. Because this interaction is not initiated by the user and offers no immediate perceived value, it is often an unwanted chore.

As such, existing data backup systems do not adequately help users protect themselves from data loss because they treat all data the same, thereby preventing the user from being able to treat data with different levels of care.

### SUMMARY

According to an embodiment of the present invention, a method implementable by an electronic system comprises identifying an event corresponding to a data set, the data set being of a type of a plurality of data-set types; identifying the type of the data set; identifying an association between the type of the data set and an entity of a plurality of entities; and instructing the entity to perform an action with respect to the data set.

### BRIEF DESCRIPTION OF THE DRAWING

FIG. 1 is a logical block diagram of an event-processing system according to an embodiment of the invention;

FIG. 2 is a logical block diagram of the file system monitor of FIG. 1 according to an embodiment of the invention;

FIG. 3 is a logical block diagram of the event processor of FIG. 1 according to an embodiment of the invention;

FIG. 4 is a logical block diagram of the processing rules engine of FIG. 1 according to an embodiment of the invention; and

FIG. 5 is a logical block diagram of the preservation provider of FIG. 1 according to an embodiment of the invention.

### DETAILED DESCRIPTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numbers signify like elements throughout the description of the figures.

The present invention may be embodied as methods, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer usable or computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

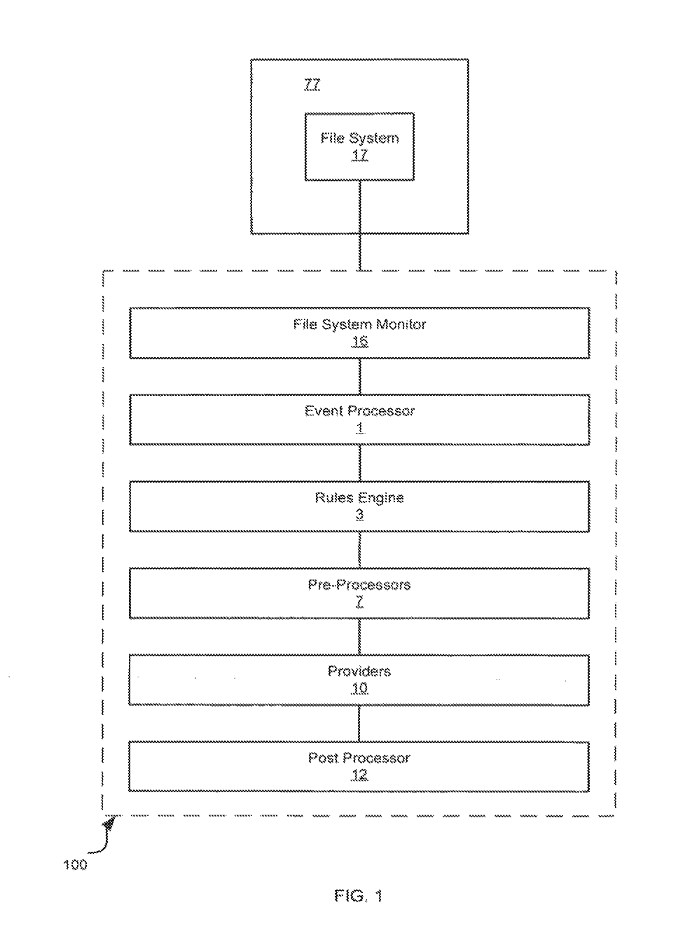

FIG. 1 illustrates, in logical block diagram form, a system 100 according to an embodiment of the invention. The system 100 may reside in a memory (not shown) and be executed by a processor (not shown) of an electronic system, such as a personal computer, workstation, or the like.

In an embodiment of the invention, a user first runs a software installer on the electronic system that will store components of and execute the system 100. This installer may be provided on disc or other media, or may be downloaded from the Internet, and facilitates installation of the system 100.

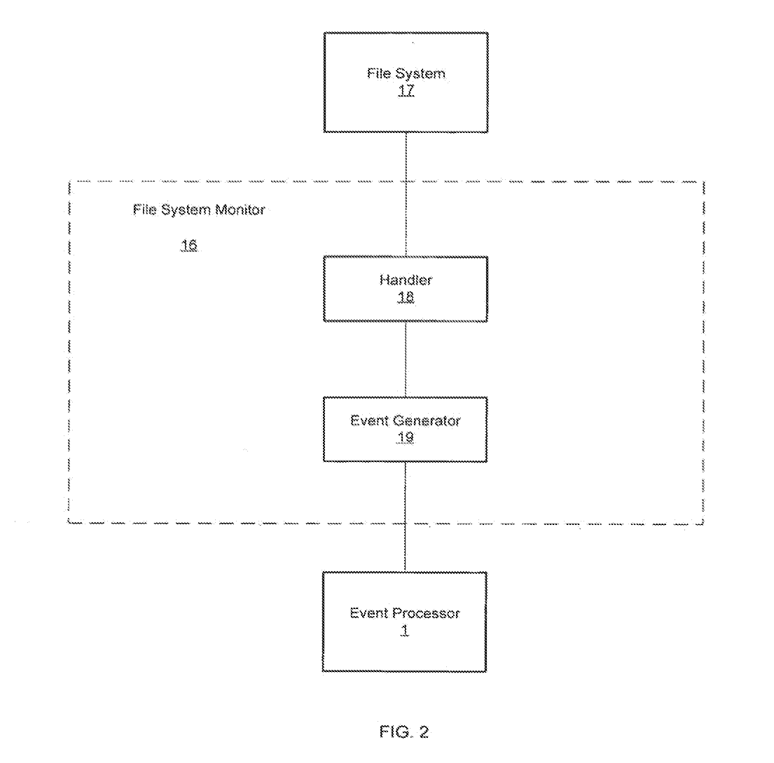

In an embodiment, the system 100 includes a file system monitor 16 shown in detail in FIG. 2. The monitor includes a handler 18 and an event generator 19. The handler 18 may be responsible for consuming events that are generated by the file system 17. These events may correspond to create/delete/modified events (discussed more fully hereinafter) that occur to files in the file system 17. The handler 18 may identify whether the event should be passed on to the event processor 1 by referring to a blacklist configuration table (not shown) that may reside in the memory within which the system 100 resides or a memory accessible to the system 100. The handler 18 may thus function to reduce processing overhead by only filtering out events that pertain to data sets, such as files or folders, designated by the blacklist table. Once the handler 18 has determined that the event in question is to be passed along, the event generator 19 creates a new platform-independent event structure (“event object”) that contains the information about the change and passes the event object to the event processor 1.

The monitor 16 is operable to monitor creation and modification of files stored in a user's memory 17 associated with an electronic system 77 operable to create and store sets of data (e.g., files, file groups, etc.). The monitor 16 may further be operable to monitor events, such as registry changes, not pertaining to files. It should be noted that the system 100 may be stored and run on the electronic system 77 associated with the monitored memory 17. Alternatively, in order to perform remotely the functions described herein, the system 100 may be stored and run on an electronic system other than, but in communication with, the electronic system 77 associated with the monitored memory 17.

The monitor 16 watches for changes to data sets stored in the memory 17. In an embodiment, such changes may include, for example, creation of a file, modification of an existing file, and deletion of an existing file. As previously described, in the event of such a change, the event generator 19 may generate an event object characterizing the change. In an embodiment, and as discussed in detail below, the event object includes information describing both the type of change and at least one characteristic of the file changed. The monitor 16 may then inject the event object into an event processor 1. This method of using the system 100 ensures that the user's files are, if desired, backed up as soon as the files change.

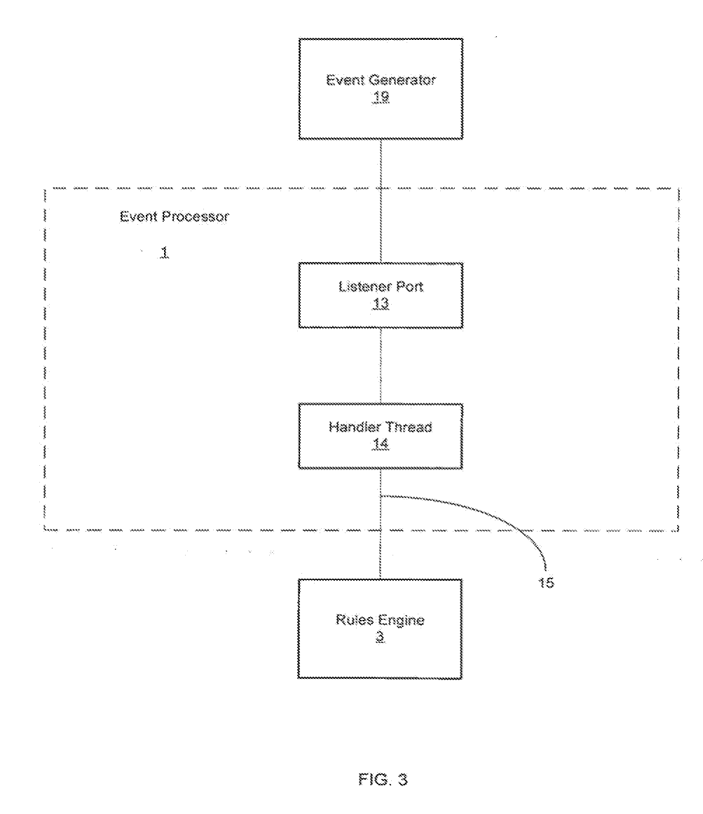

The event processor 1 is the starting point for event object processing in the system 100. As illustrated in FIG. 3, the event processor 1 includes a listening port 13, a handler thread 14, and an output queue reference 15.

The listening port 13 awaits event objects to be delivered by other processes, such as the event generator 19 of the file system monitor 16, running on the computer 77. In order to be able to deliver an event to the listening port 13, the other process must use the address of the port 13 and the format of the event object.

The address of the port 13 can be set by any means (e.g., configuration files, hard-coding, directory lookup) and use any addressing mechanism so long as the processes that wish to send event objects to the processor 1 can determine what the address is at runtime.

Any inter-process communication mechanism (e.g., socket stream, I/O channel, or a .NET Remoting Connection) can be used. Optionally, the listening port 13 can implement a security mechanism to allow only authorized processes with the appropriate credentials to deliver messages to the port 13.

In order for the processor 1 to understand the event objects delivered to it on the listening port 13, the sender must construct the event object in a way that the processor 1 expects. In an embodiment, the event object is configured to communicate the following information:

Creator ID, which may be a unique identifier of the component (e.g., event generator 19) that created the event object;

Type of event (e.g., a file was created/modified/deleted, a user logged in or out, a timer fired, etc.);

Time at which the event occurred;

Context (e.g., a filename, a text snippet, a system object);

Priority (e.g., low/regular/high), which may be set by the event object creator; and

Sponsors, which may be a collection of runtime components to be notified of the status of the event object as processed by the system 100.

When an event object arrives on the listening port 13, the handler thread 14 is awakened to process the event object. The handler thread 14 first checks to make sure that the event object is of the appropriate structure and format for the system 100 to process. Next the handler thread 14 checks the state of the system 100 to ensure that the system 100 is running in a normal, and not “panic,” mode. Panic mode is a state where the system 100 has determined that it is unable to accommodate the rate at which new event objects are generated for processing by the system 100. While in panic mode, the system 100 may discard all incoming event objects unless such objects are marked or otherwise designated as high-priority objects. Once the system 100 can accommodate the event-object generation rate, the system 100 resumes “normal mode” processing and event objects are no longer discarded.

Assuming the event object meets such processing requirements, the handler thread 14 places the event object at the end of the appropriate output queue 15. In an embodiment, the output queue 15 functions as a reference to a rules engine 3 input queue 23, 33 discussed in further detail below.

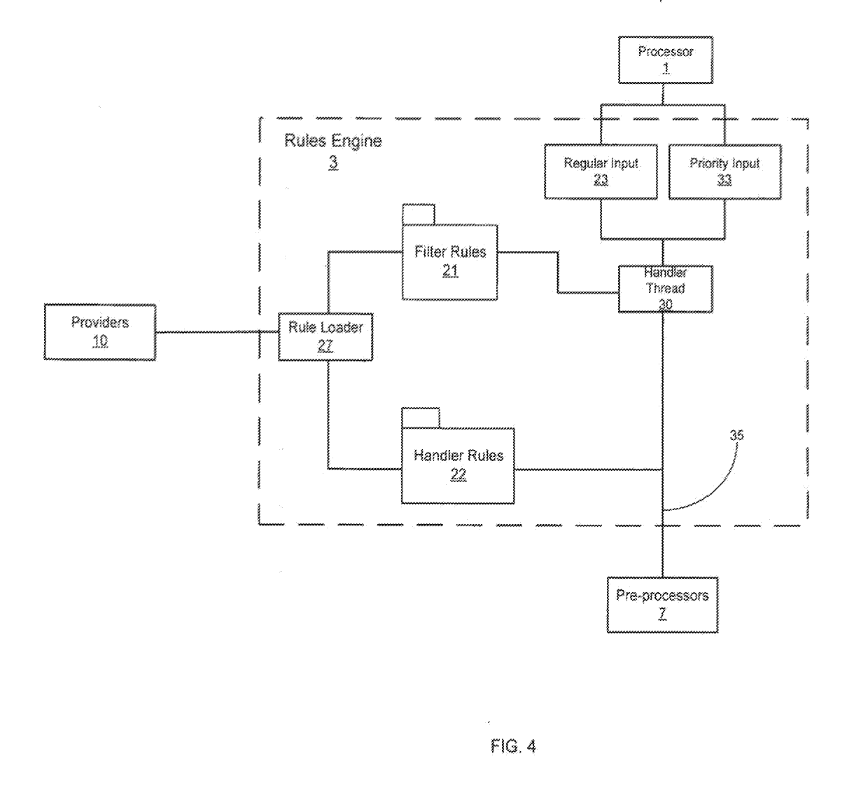

In an embodiment, the system 100 further includes the aforementioned rules engine 3. As illustrated in FIG. 4, the rule engine 3 may include a regular-event input queue 23 and a high-priority-event input queue 33, at least one handler thread 30, a filter rule set 21, a handler rule set 22, a rule loader 27, and a reference 35 to output queue.

The two input queues 23 and 33 allow other components (in an embodiment, the event processor 1) to inject event objects into the rules engine 3 for processing rule application thereto. When an event object arrives in either queue 23, 33, the associated handler thread 30 is activated and consumes the event object at the head of the queue 23, 33.

The filter rule set 21 is specific to the system 100 itself and not to any provider 10 in particular. How the filter rules 21 work is implementation-specific and not specified by the architecture of the system 100. The application of a filter rule 21 to an event object yields a Boolean logical operator specifying to the handler thread 30 whether the event object should be further processed by the system 100.

In an embodiment, the one required filter rule 21 is a panic-mode filter rule implemented by the handler thread 30. This panic-mode filter rule discards any event objects that, for whatever reason, arrive on the regular input queue 23 when the system 100 is in panic mode. Other exemplary filter rules may include a rule that causes any event pertaining to a file larger than a predetermined threshold size (e.g., 100 MB) or to a system file to be ignored.

The handler thread 30 applies the filter rules 21 to the event object in order to determine whether the event object should be handled at all. If application of the filter rules 21 determines that the event object should not be handled, then the event object is discarded and no further processing is done for that event object.

If, after application of the filter rules 21, the event object persists, it is processed through the handler rules 22. Handler rule 22 processing of the event object yields an identifier (instance identifier) that specifies which of a plurality of preservation providers 10 (discussed in further detail below) will act with respect to the data set associate with the event object.

The rules in the handler rule set 22 are specified by the configuration of the individual preservation providers 10. For example, a user may configure a preservation provider 10 that backs up files to a file server to back up files only in his My Documents folder. The preservation provider 10 is operable to create an appropriate representation of the rules that are specified by this configuration. In an embodiment, this representation is expressed in extensible markup language (XML).

The application of a handler rule 22 to an event object yields a unique identifier of a provider 10 instance that is to handle the event object. It is possible that more than one rule 22 can return an instance identifier associated with a particular provider 10. In this case, the event object is processed by multiple provider 10 instances.

The rule loader 27 is responsible for discovering and loading into memory all of the filter rules 21 and handler rules 22 that have been set by the preservation providers 10.

Once the handler rules 22 have processed an event object and returned the instance identifier(s) of the preservation providers 10 that are to handle the event object, the event object is passed to the appropriate output queue(s) 35. In an embodiment the output queue 35 is a reference to the pre-processors 7.

The pre-processors 7 execute business logic on all event objects before the event objects are passed to the providers 10. The pre-processors 7 may, for example, write performance/trace information to a log file for debugging/performance monitoring. Pre-processors 10 handle all event objects regardless of the determination that is made by the rules engine 3 for how an event object is to be handled. The pre-processors 7 handle the event object sequentially, until the final pre-processor 7 passes the event object to the appropriate preservation provider(s) 10. In an embodiment, the only pre-processor 7 is one that passes the event object to the input queue of the appropriate preservation provider 10.

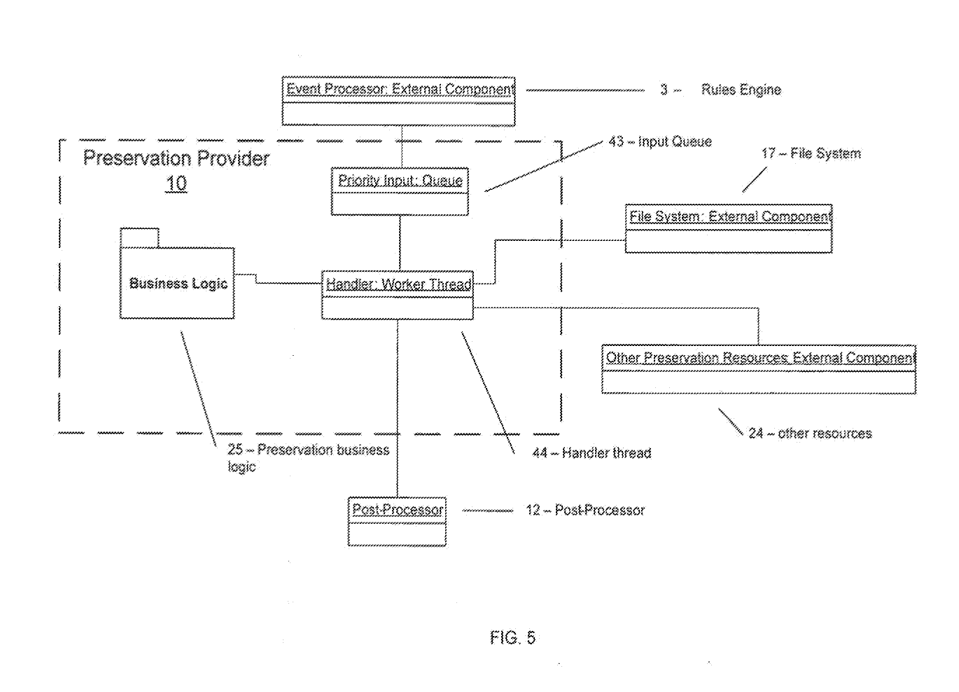

As illustrated in FIG. 5, a preservation provider 10 may include an input queue 43, handler thread 44, and a business-logic module 25. The providers 10 are, in an embodiment, “plug-in” modules that can be updated and augmented over time. Additional providers 10 can be installed after initial installation of the system 100. Each of the providers 10 has a particular method of preserving user data associated with an event object.

By way of example, and not limitation, the following exemplary providers 10 are included in an embodiment:

a “File Copy” provider that preserves files by copying them from a memory associated with a user's computer to a separate location on the user's computer, or to another computer on a network;

a “Remote Server” provider that preserves files by copying them from a memory associated with a user's computer to a remote server (such as one managed by an internet service provider) on the Internet;

a “Digital Safe Deposit Box” provider that preserves files by encrypting and sending them to a secure server run by a trusted entity such as a financial institution;

a “Digital Photo Album” provider that preserves digital photo files (e.g., jpegs), by copying them to the user's account storage at an online digital photo service provider such as Shutterfly™ or Ofoto™;

A “Removable Device” provider that preserves files by copying them to a removable device such as a static memory “keychain drive.”

The input queue 43 receives from other components of the system 100 (in an embodiment, the rule engine 3) event objects identifying items, such as files, for which preservation (e.g., backup storage, rendering, etc.) is desired. The provider's 10 handler thread 44 services the queue 43, dequeueing from the head of the queue 43 and executing the appropriate business logic 25 to preserve the file identified in the event object in the desired manner.

The business logic 25 used by an individual provider 10 is not specified by the architecture of the system 100. In executing the business logic 25, a provider 10 could, for example, and as discussed above, copy the file to another location, email the file somewhere, or even print out the file.

Once the preservation provider 10 has concluded processing the event object, the provider 10 delivers the event object to the post processor 12. The post processor 12 is responsible for handling any cleanup and housekeeping, such as deallocating memory and releasing resources, associated with the event object. In an embodiment, the only post processor 12 is one that disposes of the event object.

In an embodiment, the system 100 may further include a configuration manager (not shown) that enables the user to express which providers 10 to use, and to provide the necessary settings for the providers 10 to do what the user wants. This configuration manager is responsible for generating the XML files containing the processing rules for each provider 10. The configuration manager may interface with the user via, for example, a dialog box or other graphical user interface displayable on a display device.

In operation, according to an embodiment of the invention, a user selects which providers 10 he wishes to use and provides, via, for example, the configuration manager, the appropriate information to configure the providers 10. For example, a File Copy provider must know the path to the destination directory where files are to be sent. It should be noted that the user can elect to employ multiple instances of the same provider type. For example, the user can configure one instance of the File Copy provider to send files to Server A, and another instance to send files to Server B.

The system 100 generates a set of rules for processing files on the monitored memory 17. In order to generate these rules, the system may function to determine, for example, the types of application programs installed on the computer 77, the file types (e.g., “.doc, .htm”) generated by those applications, the specific storage location of a subject file, and the folders designated by an operating system for special purpose use (e.g., “My Pictures,” “My Documents”). The system 100 may further determine which of the above folders and/or file types the user wishes to have preserved (i.e., “Preserve all documents I create with Microsoft Word, no matter where they're stored,” “Preserve all digital images in the My Pictures folder, no matter what application created them”), and, for each folder and/or file type selection, which provider (or provider instance) the user wishes to assign to handle the selected item.

Subsequently, and as described above, the system 100 monitors operations performed on the computer 77. As files are created, changed, or deleted, the system 100 executes logic associated with the appropriate rule(s) governing the processing of the affected file. A message is sent to the appropriate provider or set of providers 10 to take the necessary action (e.g., copy the file to a remote location) to preserve the data. It should be noted that, depending on the preference of the user, the system 100 may either send the file/folder itself to an entity (e.g., memory, server, person, etc.), thus removing this file/folder from the memory 17, or create a duplicate of the file/folder to send to the entity, thus providing storage of the file/folder in two or more locations.

The provider 10 keeps a record of its actions so that the system 100 can display to the user details of how his or her data has been preserved.

An embodiment of the invention provides a multiplexed data preservation system 100. The system has multiple, plug-in providers 10, each of which employs a different method of preserving user data. Instead of employing a single mechanism of transferring the user's data from point A to point B, the system 100 employs many mechanisms and allows the user to select which mechanism best fits his needs for various data set types. These providers 10 can be configured by the user according to a set of rules that enable the user to specify how various items in his file system should be preserved.

For example, the user can specify that tax-related documents be encrypted and sent to a secure server, digital pictures be made available for viewing by sending them to a photo service provider on the Internet, and email messages be copied to a folder on the local disk every night. Data need not be preserved electronically. For example, a provider 10 can be created to preserve digital photographs by sending them to a third-party service that will print the photos and mail the prints back to the user.

An added benefit of preserving data according to a characteristic of the data is that the user can configure the system 100 to do more than just “back up” the data, but also make the data more useful or available in its preserved state. For example, the user may have a computer, separate from his desktop system, that is attached to his television for the purpose of recording TV shows, playing music through the stereo system, or watching slideshows. With the proper configuration, the system 100 can automatically copy photos that are downloaded to the desktop PC to the computer that is attached to the television. In so doing, the system 100 takes care of the chore of making the photos available for viewing as a slide show on the television.

Moreover, by routing different types of files to different providers based on a set of rules, large files such as digital pictures, music files and home movies can be sent to the appropriate service provider, so the user doesn't have to store them on CD, tape, etc. The system 100 keeps track of all preserved files for the user, so that when it comes time to restore a version of a file, the system can determine where the file is and help the user through the process of restoring it. In addition, because the system 100 reduces or eliminates the reliance on removable media, this location/restoration problem is alleviated.

By enabling the user to specify what is to be backed up based on, for example, the applications they use, and not simply by specifying locations in the folder hierarchy on disk, the system 100 ensures that the files the user cares about are preserved no matter when they're stored on disk. When, for example, duplicate files are present on the user's PC, only one copy need be transferred or stored on a provider's backing store. In addition, by running in the background and using the rules garnered from the user, the system 100 need not ask the user for any instruction input in preserving data unless it encounters some kind of exceptional condition.

It should further be noted that, in an embodiment, the system 100, when first installed or otherwise, may perform a “scan” of all files present in the memory 17 in order to apply a set of default rules to and, consequently, preserve, as appropriate, such files in a manner described herein.

Computer program code for carrying out operations of embodiments of the present invention may be written in an object-oriented programming language, such as JAVA, Smalltalk, or C++. Computer program code for carrying out operations of embodiments of the present invention may also, however, be written in conventional procedural programming languages, such as the C programming language or compiled Basic (CBASIC). Furthermore, some modules or routines may be written in assembly language or even micro-code to enhance performance and/or memory usage.

Embodiments of the present invention have been described with reference to block diagram illustrations of methods, systems, and/or computer program products according to at least one embodiment of the invention. It will be understood that each block of the block diagram illustrations, and combinations of blocks in the block diagram illustrations, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block diagram block or blocks.

These computer program instructions may also be stored in a computer-usable or computer-readable memory that can direct a computer or other programmable data processing apparatus to function in a particular manner, such that the instructions stored in the computer-usable or computer-readable memory produce an article of manufacture including instruction means that implement the function specified in the block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block diagram block or blocks.

Some additional features of embodiments of the invention include the following:

a method wherein performing an action with respect to the data set comprises compressing the data set.

a method wherein performing an action with respect to the data set comprises determining that the entity need not perform any processing because it has already processed the data set.

a method wherein the data set is transformed into a higher or lower resolution while being processed by the entity.

a method wherein performing an action with respect to the data set comprises sending the data set to an online photo album service.

a method wherein the data set is transformed into a higher or lower resolution while being processed by the entity.

a system wherein said user interface includes controls for specifying data sets of various type and content be handled by different entities.

a system wherein said user interface includes controls for specifying that a data set content be handled by two or more entities.

a system wherein said user interface includes controls that describe the totality of user data to be preserved, the totality of available resources in the available entities for preserving said user data, and the difference between those totalities.

a system wherein said user interface includes a control that reconciles the difference in totalities with a single click or keystroke.

a system wherein said method begins processing the event as immediately upon delivery from the operating system.

a system wherein said method begins processing the event on a periodic basis.

a system wherein said method buffers events for a period of time so that multiple system events may be combined into a single processing event.

a system wherein said method postpones the processing of events while the associated entity or entities is unable to process the event.

a system wherein the entity is unable to process events due to unavailability of resources.

a system wherein said method postpones the processing of events for a specific entity while continuing to process events associated with other entities.

a system wherein said method resumes processing of events upon notification by the entity that necessary resources have returned.

a system wherein the required resource is disk space.

a system wherein the required resource is a network connection.

a system wherein the required resource is a remote computer.

a system wherein said user interface is presented to the user when an entity in unable to process events due to the unavailability of storage space.

a system wherein the processing of events pauses upon shutdown of the host computer and resumes at startup.

The preceding discussion is presented to enable a person skilled in the art to make and use the invention. Various modifications to the disclosed embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

We claim:

1. A computer-readable physical medium including computer-executable instructions which, when executed on a data processing system, perform at least the steps of:
receiving from a user a plurality of user preferences identifying respective backup destinations associated with a plurality of digital files, each digital file having been generated by an application of a plurality of applications;
determining a change in state of a first file of the plurality of digital files;
identifying the application that generated the first file;
identifying, based on the identified application, from the user preferences a first backup destination to which the user desires the first file to be stored; and
in response to determining the change in state of the first file and identifying the first backup destination, automatically transmitting the first file to the first backup destination.

2. The medium of claim 1 wherein the change in state is of a type of a plurality of change-in-state types.

3. The medium of claim 2 wherein the destination depends on the change-in-state type.

4. The medium of claim 1 wherein the change in state comprises creation of the first file.

5. The medium of claim 1 wherein the change in state comprises modification of the first file.

6. The medium of claim 1 wherein the change in state comprises deletion of the first file.

7. The medium of claim 1 wherein the first file comprises a file created by a digital camera, scanner, or other digital photographic transformation.

8. The medium of claim 1 wherein all user preferences are created by the user.

9. The medium of claim 1 wherein the first destination is remote from the data processing system.

10. The medium of claim 1 wherein the first destination comprises an electronic memory.

11. The medium of claim 1 wherein the first destination comprises a printer.

12. The medium of claim 1, further comprising instructions to encrypt the first file.

13. The medium of claim 1, further comprising instructions to provide an instruction to the first destination to store the first file.

14. The medium of claim 1, further comprising instructions to provide an instruction to the first destination to delete the first file.

15. The medium of claim 1, further comprising instructions to provide an instruction to the first destination to print a graphic image represented by the first file.

16. The medium of claim 1 wherein the first file is a duplicate of a second file of the plurality stored in a memory of the data processing system.

17. A computer-readable physical medium including computer-executable instructions which, when executed on a data processing system, perform at least the steps of:
determining a change in state of a first file of a plurality of files, each file having been generated by an application of a plurality of applications;
identifying the application that generated the first file;
identifying, based on the identified application, from user preferences a first backup destination to which the user desires the first file to be stored;
in response to determining the change in state of the first file, automatically creating a backup copy of the first file; and
in response to identifying the first backup destination, automatically transmitting the backup copy to the first backup destination.

18. A computer-readable physical medium having computer-executable components comprising:
an identifier component operable to detect an event corresponding to a data set, the data set being of a type of a plurality of data-set types and having been generated by an application of a plurality of applications, the identifier component further operable to identify the application that generated the data set, the identifier component further operable to determine an association between the identified application and a destination entity of a plurality of destination entities configured to received the data set; and
an instructor component operable, in response to the identifier component detecting the event and identifying the application that generated the data set, to instruct the destination entity to perform an action with respect to the data set.

19. A computer-readable physical medium including computer-executable instructions which, when executed on a data processing system, perform at least the steps of:
receiving from a user a plurality of user preferences identifying respective backup destinations associated with a plurality of digital files, each digital file having been generated by an application of a plurality of applications;
determining a change in state of a first file of the plurality of digital files, the first file being configured in a first format;
identifying the application that generated the first file;
identifying, based on the identified application, from the user preferences a first backup destination to which the user desires the first file to be stored;
in response to determining the change in state, automatically configuring the first file in a second format different from the first format and appropriate to the first backup destination; and
in response to identifying the first backup destination and configuring the first file in the second format, automatically transmitting the first file to the first backup destination.

20. A computer-readable physical medium including computer-executable instructions which, when executed on a data processing system, perform at least the steps of:
receiving from a user a plurality of user preferences identifying respective backup destinations associated with a plurality of digital files, each digital file having been generated by an application of a plurality of applications;
determining a change in state of a first file of the plurality of digital files, the first file being configured in a first format;
identifying the application that generated the first file;
identifying, based on the identified application, from the user preferences a first backup destination to which the user desires the first file to be stored;
in response to determining the change in state, creating a backup copy of the first file, the backup copy configured in a second format different from the first format and appropriate to the first destination; and
transmitting the backup copy to the first destination.
